(19) United States
(12) Patent Application Publication
(10) Pub. No.: US 2019/0010982 A1
(43) Pub. Date: Jan. 10, 2019

(54) FAN AND ROTOR AND PERMANENT MAGNETIC MEMBER THEREOF

(71) Applicant: ASIA VITAL COMPONENTS CO., LTD., New Taipei City (TW)

(72) Inventor: Meng Shen, New Taipei City (TW)

(21) Appl. No.: 15/643,478

(22) Filed: Jul. 7, 2017

(51) Int. Cl. F16C 32/04

(52) U.S. Cl. CPC F16C 32/0474

(57) ABSTRACT

A fan, a rotor and a permanent magnetic member thereof are disclosed. The permanent magnetic member includes a main body. The main body has multiple first magnetic pole section, multiple second magnetic pole sections and multiple complex magnetic pole sections. The first and second magnetic pole sections are disposed on the main body in adjacency to each other. Each complex magnetic pole section is positioned between each two first magnetic pole sections to separate each two first magnetic pole sections. Each complex magnetic pole section is positioned between each two second magnetic pole sections to separate each two second magnetic pole sections. Each complex magnetic pole section has at least one N-pole section and at least one S-pole section. The permanent magnetic member can achieve the effects of room-saving and weight reduction.

### BACKGROUND OF THE INVENTION

### 1. Field of the Invention

The present invention relates generally to a fan, and more particularly to a fan, a rotor and a permanent magnetic member thereof. The permanent magnetic member can achieve the effects of room-saving and weight reduction and enhance the magnetic flux sine property.

### 2. Description of the Related Art

Along with the increasing popularization of personal computers and flouring development of computer industries, it has become more and more critical and important how to solve the heat generation and heat dissipation problems of various electronic components. Currently, there is a trend to employ cooling fan as the major heat dissipation component. Various cooling fans are widely used in the field of computers. The cooling fan has a simplified structure and small volume and is able to quickly dissipate the heat generated by the electronic components.

Please refer to FIGS. 1, 2A, 2B and 2C. The conventional centrifugal fan 1 is composed of a rotor 10, a stator 11 and a frame body 12. The rotor 10 is received in the frame body 12. The rotor 10 is composed of a fan impeller 101, a rotor yoke 102 (metal-made motor iron case) and a permanent magnet 103. The permanent magnet 103 has multiple N-poles and multiple S-poles alternately arranged on the permanent magnet 103. The rotor yoke 102 is disposed on the inner circumference of a hub 1011 of the fan impeller 101. Multiple blades 1012 are annularly disposed on the outer circumference of the hub 1011. The permanent magnet 103 is disposed on the inner circumference of the rotor yoke 102. The stator 11 is composed of a stator iron core 111 and a winding assembly 112 wound around the stator iron core. The stator iron core 111 is formed of multiple stacked silicon steel sheets. The stator 11 is disposed around a bearing cup 121 of the frame body 12. A shaft 105 of the rotor 10 is rotatably disposed in the bearing cup 121. When the centrifugal fan 1 operates, the permanent magnet 103 of the rotor 10 and the stator 11 interact with each other by means of induction and magnetization, whereby the rotor 10 is driven to rotate for guiding airflow to forcedly dissipate the heat.

The permanent magnet 103 is generally multipole magnetized. In addition, it is necessary to mount the permanent magnet 103 on the motor iron case, (that is, the rotor yoke 102). Almost all the magnetic flux of the adjacent poles of the permanent magnet 103 with different polarities participates in the magnetic loop. Also, in order to make the magnetic path of the permanent magnet 103 form a closed loop, the rotor yoke 102 (the motor iron case) must be made of iron material (permeable material) so as to avoid loss of the rotor. Therefore, the rotor yoke 102 mainly serves to shield the inner magnetic loop of the permanent magnet 103 to form a closed loop (as shown in FIG. 2C). However, this leads to another problem, that is, the rotor yoke 102 will increase the total weight of the rotor 10 and occupy much interior room of the hub 1011. As a result, the air gap magnetic flux density is lowered and the magnetic flux sine property is poor.

### SUMMARY OF THE INVENTION

It is therefore a primary object of the present invention to provide a rotor permanent magnetic member, which can save the room and reduce the total weight of the rotor.

It is a further object of the present invention to provide the above permanent magnetic member, which can save the cost and enhance the air gap magnetic flux density and achieve better magnetic flux sine property.

It is still a further object of the present invention to provide a rotor, which can save the room and reduce the total weight.

It is still a further object of the present invention to provide the above rotor, which can save the cost and enhance the air gap magnetic flux density and achieve better magnetic flux sine property.

It is still a further object of the present invention to provide the above rotor, in which the permanent magnetic member is formed by means of radial multipole double-ring cross array magnetization so that the conventional rotor yoke component can be omitted.

It is still a further object of the present invention to provide the above rotor, in which the permanent magnetic member is formed by means of radial multipole double-ring cross array magnetization so that the rotor yoke can be made of impermeable material (such as plastic or aluminum material) to save cost and reduce the weight.

It is still a further object of the present invention to provide a fan, which can save the room and reduce the total weight.

It is still a further object of the present invention to provide the above fan, which can save the cost and enhance the air gap magnetic flux density and achieve better magnetic flux sine property.

To achieve the above and other objects, the rotor permanent magnetic member of the present invention includes a main body. The main body has multiple first magnetic pole section, multiple second magnetic pole sections and multiple complex magnetic pole sections. The first and second magnetic pole sections are disposed on the main body in adjacency to each other. Each complex magnetic pole section is positioned between each two first magnetic pole sections to separate each two first magnetic pole sections. Each complex magnetic pole section is positioned between each two second magnetic pole sections to separate each two second magnetic pole sections. Each complex magnetic pole section has at least one N-pole section and at least one S-pole section. Therefore, the design of the permanent magnetic member of the present invention can achieve the effects of product room-saving and product weight reduction. In addition, the permanent magnetic member of the present invention can enhance the air gap magnetic flux density and achieve better magnetic flux sine property.

Still to achieve the above and other objects, the rotor of the present invention includes a fan impeller and a permanent magnetic member. The fan impeller includes a hub and multiple blades annularly arranged on an outer circumference of the hub. The hub has a receiving space. The permanent magnetic member is disposed on an inner circumference of the hub in the receiving space. The permanent magnetic member includes a main body. The main body has multiple first magnetic pole section, multiple second magnetic pole sections and multiple complex magnetic pole sections. The first and second magnetic pole sections are disposed on the main body in adjacency to each other. Each complex magnetic pole section is positioned between each two first magnetic pole sections to separate each two first magnetic pole sections. Each complex magnetic pole section is positioned between each two second magnetic pole sections to separate each two second magnetic pole sections. Each complex magnetic pole section has at least one N-pole section and at least one S-pole section. Therefore, the design of the rotor of the present invention can achieve the effects of product room-saving and product weight reduction. In addition, the rotor of the present invention can enhance the air gap magnetic flux density and achieve better magnetic flux sine property.

Still to achieve the above and other objects, the fan of the present invention includes the above rotor. The fan of the present invention can enhance the air gap magnetic flux density and achieve better magnetic flux sine property.

Alternatively, the rotor permanent magnetic member of the present invention includes a main body. The main body has multiple first magnetic pole section and multiple second magnetic pole sections. The first and second magnetic pole sections are alternately arranged on the main body in adjacency to each other. Each first magnetic pole section is formed with a magnetic pole section as a part of the first magnetic pole section with a polarity different from the polarity of the first magnetic pole section. Each second magnetic pole section is formed with a magnetic pole section as a part of the second magnetic pole section with a polarity different from the polarity of the second magnetic pole section. Therefore, the design of the permanent magnetic member of the present invention can achieve the effects of product room-saving and product weight reduction. In addition, the permanent magnetic member of the present invention can enhance the air gap magnetic flux density and achieve better magnetic flux sine property.

In the above rotor permanent magnetic member, one side of each first magnetic pole section is adjacent to one side of each second magnetic pole section and the other side of each first magnetic pole section is adjacent to each complex magnetic pole section. The other side of each second magnetic pole section is adjacent to each complex magnetic pole section.

In the above rotor permanent magnetic member, the first and second magnetic pole sections are formed on the main body by means of radial magnetization. The first magnetic pole sections are N-pole sections or S-pole sections. The second magnetic pole sections are S-pole sections or N-pole sections.

In the above rotor permanent magnetic member, the N-pole section and S-pole section of each complex magnetic pole section are formed on the main body by means of radial magnetization. The N-pole section and S-pole section between each two first magnetic pole sections are respectively disposed in adjacency to an inner circumference of the main body and an outer circumference of the main body. The N-pole section and S-pole section between each two second magnetic pole sections are respectively disposed in adjacency to the outer circumference of the main body and the inner circumference of the main body.

In the above rotor permanent magnetic member, the main body is a permanent magnet.

In the above rotor permanent magnetic member, the first and second magnetic pole sections are forward and backward radially side by side arranged in adjacency to each other and the N-pole section and S-pole section of each complex magnetic pole section are left and right radially side by side arranged in adjacency to each other.

In the above rotor permanent magnetic member, the main body is formed by means of radial multipole double-ring cross array magnetization.

In the above rotor, the impermeable material is plastic material or aluminum material.

In the above rotor, the hub is made of plastic material and no rotor yoke is disposed in the hub. The permanent magnetic member is directly adhered to the inner circumference of the hub in the receiving space.

In the above rotor, the hub is made of plastic material and a rotor yoke is disposed in the hub. The rotor yoke is made of impermeable material. The rotor yoke is disposed on the inner circumference of the hub in the receiving space and positioned between the main body and the hub. The permanent magnetic member being is and adhered to the inner circumference of the rotor yoke.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a conventional centrifugal fan;

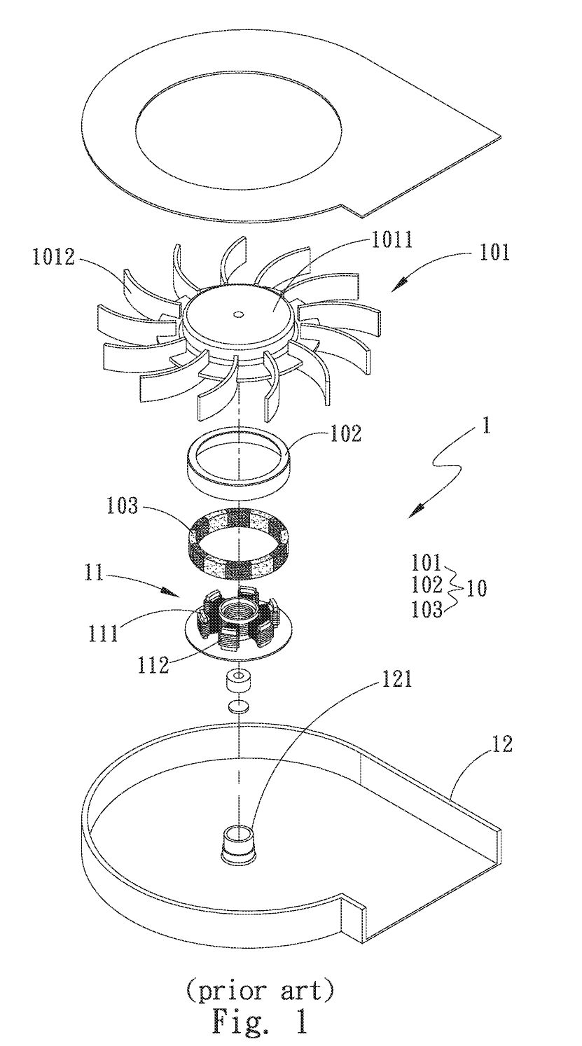

FIG. 2A is a sectional assembled view of the conventional centrifugal fan;

FIG. 2B is a top view of the permanent magnet of the conventional centrifugal fan;

FIG. 2C is a magnetic force line distribution diagram of the permanent magnet and the rotor yoke of the conventional centrifugal fan;

FIG. 3 is a top view of the permanent magnetic member of a preferred embodiment of the present invention;

FIG. 3A is a magnetic force line distribution diagram of the permanent magnetic member of the preferred embodiment of the present invention;

FIG. 4 is a magnetic force line distribution diagram of another permanent magnetic member of the preferred embodiment of the present invention;

FIG. 5 is a perspective exploded view of the preferred embodiment of the present invention;

FIG. 6 is a sectional assembled view of the preferred embodiment of the present invention;

FIG. 7 is the magnetic-flux density to magnetic-field intensity (B-H) curves of the present invention and the conventional device; and

FIG. 8 is a sectional assembled view of another preferred embodiment of the present invention.

### DETAILED DESCRIPTION OF THE PREFERRED EMBODIMENTS

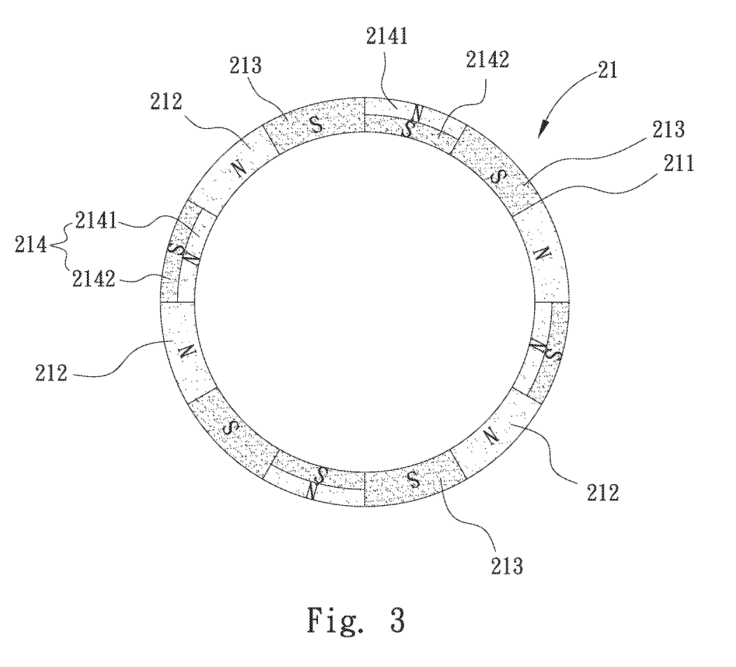

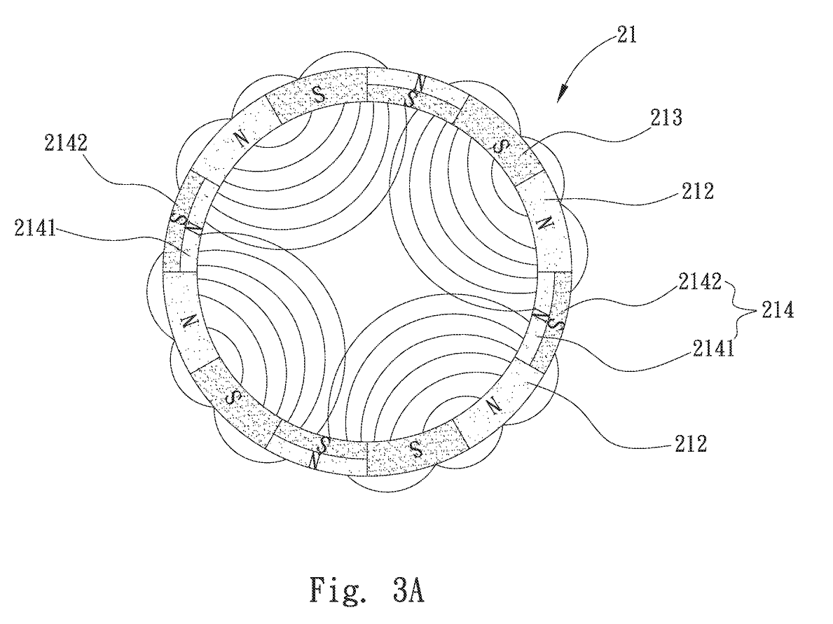

Please refer to FIGS. 3 and 3A. FIG. 3 is a top view of the permanent magnetic member of a preferred embodiment of the present invention. FIG. 3A is a magnetic force line distribution diagram of the permanent magnetic member of the preferred embodiment of the present invention. The permanent magnetic member 21 of the present invention includes a main body 211. In this embodiment, the main body 211 is a permanent magnet formed by means of radial multipole double-ring cross array magnetization. The main body 211 has multiple first magnetic pole section 212, multiple second magnetic pole sections 213 and multiple complex magnetic pole sections 214. In this embodiment, the first and second magnetic pole sections 212, 213 are, but not limited to, N-pole sections and S-pole sections respectively. In practice, the first and second magnetic pole sections 212, 213 can be alternatively S-pole sections and N-pole sections respectively. The first and second magnetic pole sections 212, 213 are disposed on the main body 211 in adjacency to each other and formed by means of radial magnetization. As shown in FIG. 3, the first and second magnetic pole sections 212, 213 are forward and backward radially side by side arranged in adjacency to each other. One side of each first magnetic pole section 212 is adjacent to one side of each second magnetic pole section 213. The other side of each first magnetic pole section 212 is adjacent to each complex magnetic pole section 214. The other side of each second magnetic pole section 213 is adjacent to each complex magnetic pole section 214.

Each complex magnetic pole section 214 is positioned between each two first magnetic pole sections 212 to separate each two first magnetic pole sections 212. Each complex magnetic pole section 214 is positioned between each two second magnetic pole sections 213 to separate each two second magnetic pole sections 213. Each complex magnetic pole section 214 has at least one N-pole section 2141 and at least one S-pole section 2142. In this embodiment, the N-pole section 2141 and S-pole section 2142 between each two first magnetic pole sections 212 are respectively disposed in adjacency to an inner circumference of the main body 211 and an outer circumference of the main body 211 and are formed by means of radial magnetization. The N-pole section 2141 and S-pole section 2142 between each two second magnetic pole sections 213 are respectively disposed in adjacency to the outer circumference of the main body 211 and the inner circumference of the main body 211 and are formed by means of radial magnetization. As shown in FIG. 3, the N-pole section 2141 and S-pole section 2142 of each complex magnetic pole section 214 are left and right radially side by side arranged in adjacency to each other. In addition, one side of the N-pole section 2141 between each two first magnetic pole sections 212 is adjacent to the inner circumference of the main body 211. The other side of the N-pole section 2141 between each two first magnetic pole sections 212 is adjacent to one side of the S-pole section 2142. The other side of the S-pole section 2142 is adjacent to the outer circumference of the main body 211. One side of the S-pole section 2142 between each two second magnetic pole sections 213 is adjacent to the inner circumference of the main body 211. The other side of the S-pole section 2142 between each two second magnetic pole sections 213 is adjacent to one side of the N-pole section 2141. The other side of the N-pole section 2141 is adjacent to the outer circumference of the main body 211.

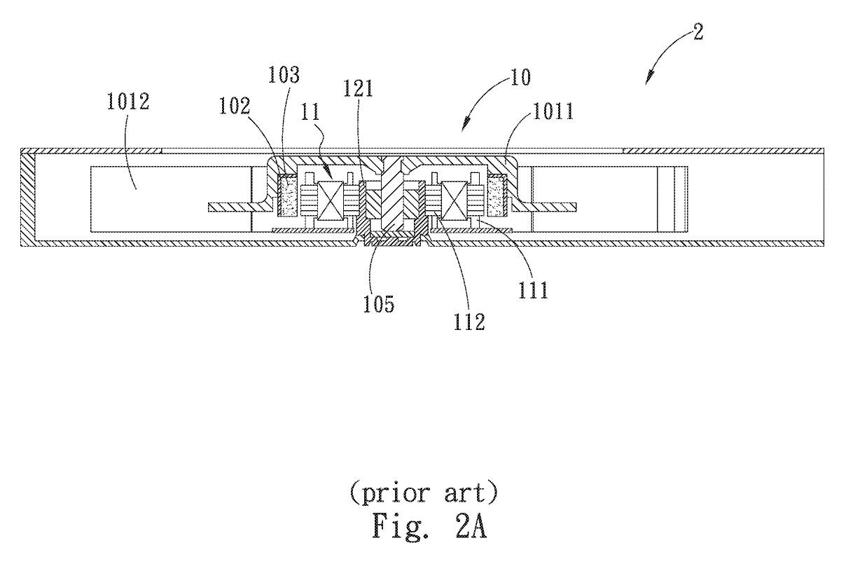

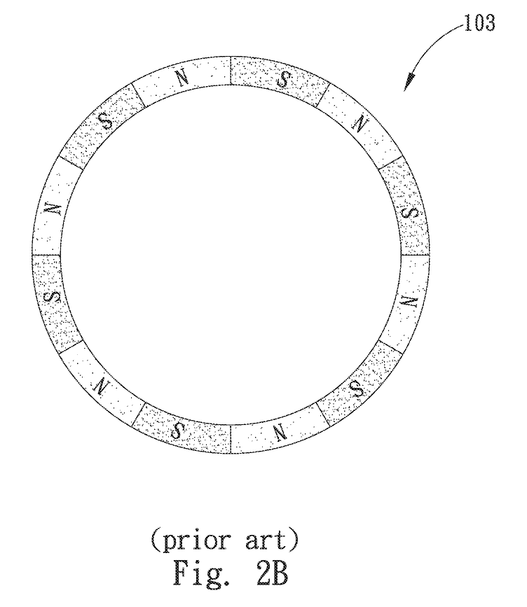

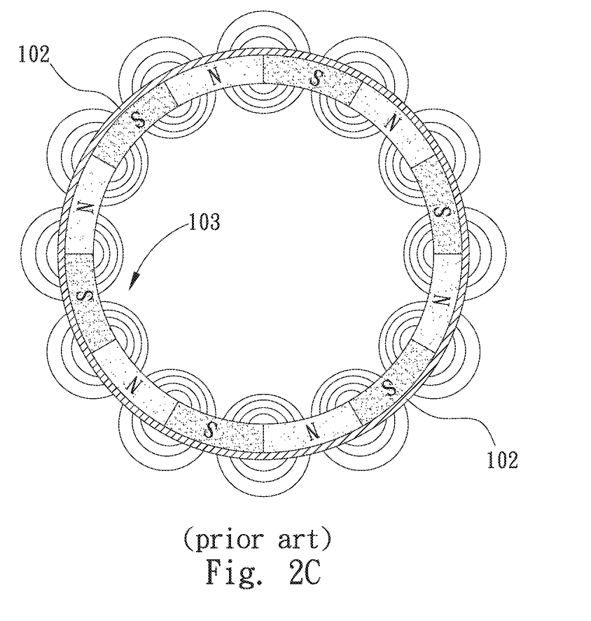

The main body 211 of the permanent magnetic member 21 is formed by means of radial multipole double-ring cross array magnetization (as shown in FIG. 3). Accordingly, the outer loop of the main body 211 (the permanent magnet) is just like the closed loop of the inner loop. As shown in FIG. 3A, the magnetic force lines of the main body 211 on the outer loop are just like the magnetic force lines of the main body 211 on the closed loop of the inner loop. Accordingly, the permanent magnetic member 21 of the present invention has a function as the conventional rotor yoke 102 (as shown in FIG. 2C). Therefore, the design of the permanent magnetic member 21 of the present invention can achieve the effects of room-saving and weight reduction. In addition, the center of each magnetic pole section (the N-pole section 2141 and S-pole section 2142 of each complex magnetic pole section 214) of the inner loop of the main body 211 has an internal independent magnetic pole-to-pole circulation. Therefore, the magnetic flux of some magnetic poles (the middle position between each first magnetic pole section 212 and each second magnetic pole section 213) of the center can be locked to participate in the circulation of the adjacent magnetic pole with different polarity. Therefore, the magnetic flux density of the center of each magnetic pole of the inner loop will be higher so that the sine property is better.

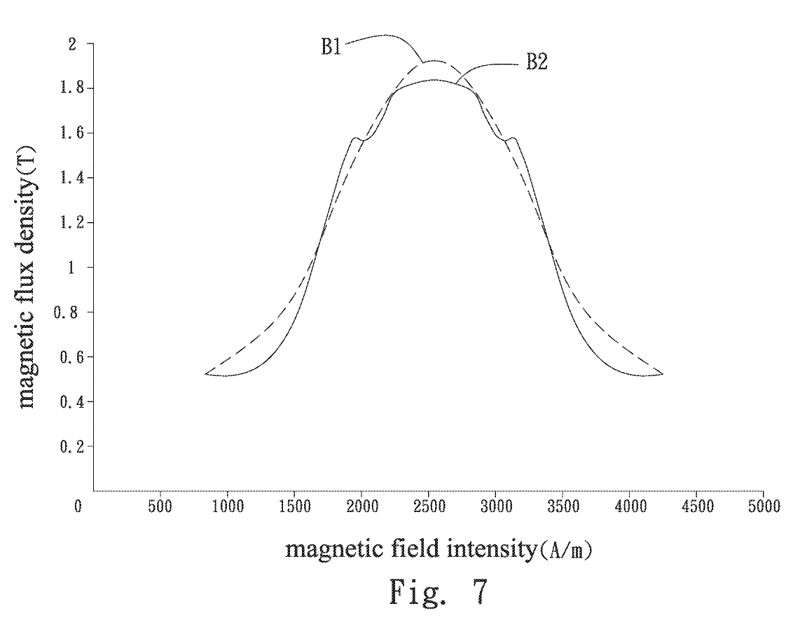

In order to more specifically describe the effect of the present invention, please refer to FIG. 7, which is the magnetic-flux density to magnetic-field intensity (B-H) curves of the present invention and the conventional device. In FIG. 7, curve B1 represents the present invention, while curve B2 represents the conventional device. It can be seen from FIG. 7 that the air gap magnetic flux density is obviously higher than the air gap magnetic flux density of the conventional device. In FIG. 7, the longitudinal axis means air gap magnetic flux density B, the unit of which is tesla (T), while the transverse axis means magnetic field intensity H, the unit of which is ampere/meter (A/m).

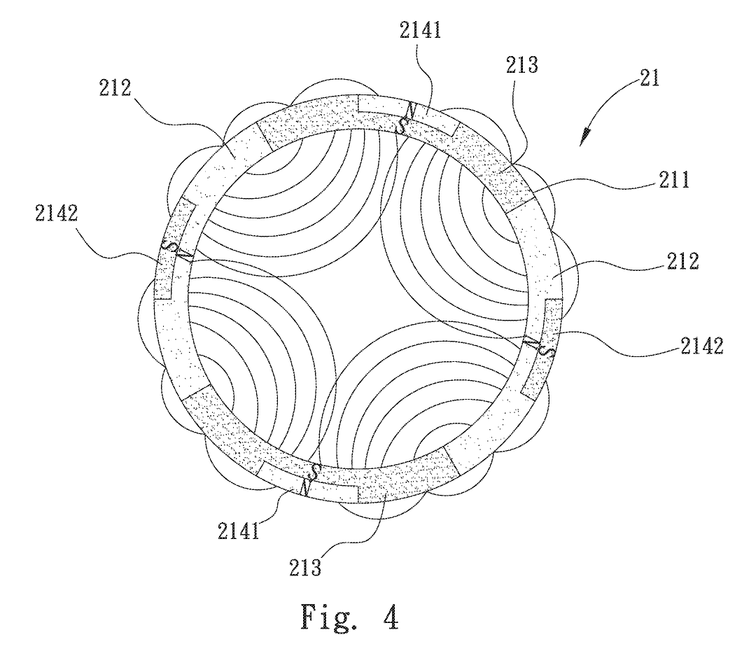

Please now refer to FIG. 4, which is a magnetic force line distribution diagram of another permanent magnetic member of the preferred embodiment of the present invention. In this embodiment, the design of the main body 211 is changed to have multiple first magnetic pole sections 212 and multiple second magnetic pole sections 213. In addition, the complex magnetic pole sections 214 between each two first magnetic pole sections 212 are changed to be deemed the same magnetic pole sections as the adjacent first magnetic pole sections 212 on two sides, (that is, the first magnetic pole sections 212). The complex magnetic pole sections 214 between each two second magnetic pole sections 213 are changed to be deemed the same magnetic pole sections as the adjacent second magnetic pole sections 213 on two sides, (that is, the second magnetic pole sections 213). Moreover, the first and second magnetic pole sections 212, 213 are alternately arranged on the main body 211 in adjacency to each other. In addition, each first magnetic pole section 212 itself is formed with a magnetic pole section as a part of the first magnetic pole section 212 (such as S-pole section 2142) with a polarity different from the polarity of the first magnetic pole section 212 (such as N-pole section). Each second magnetic pole section 213 itself is formed with a magnetic pole section as a part of the second magnetic pole section 213 (such as N-pole section 2141) with a polarity different from the polarity of the second magnetic pole section 213 (such as S-pole section). However, this is not limited. In a modified embodiment, the first magnetic pole section 212 can be an S-pole section, a part of which is an N-pole section 2141, while the second magnetic pole section 213 can be an N-pole section, a part of which is an S-pole section 2142. Accordingly, by means of the design of the first and second magnetic pole sections 212, 213 of the main body 211, the magnetic force lines of the main body 211 on the outer loop are just like the magnetic force lines of the main body 211 on the closed loop of the inner loop. Accordingly, the permanent magnetic member 21 of the present invention has a function as the conventional rotor yoke 102 (as shown in FIG. 2C). Therefore, the present invention can achieve the effects of room-saving, cost-saving and weight reduction. In addition, the present invention can effectively enhance the air gap magnetic flux density and achieve better magnetic flux sine property.

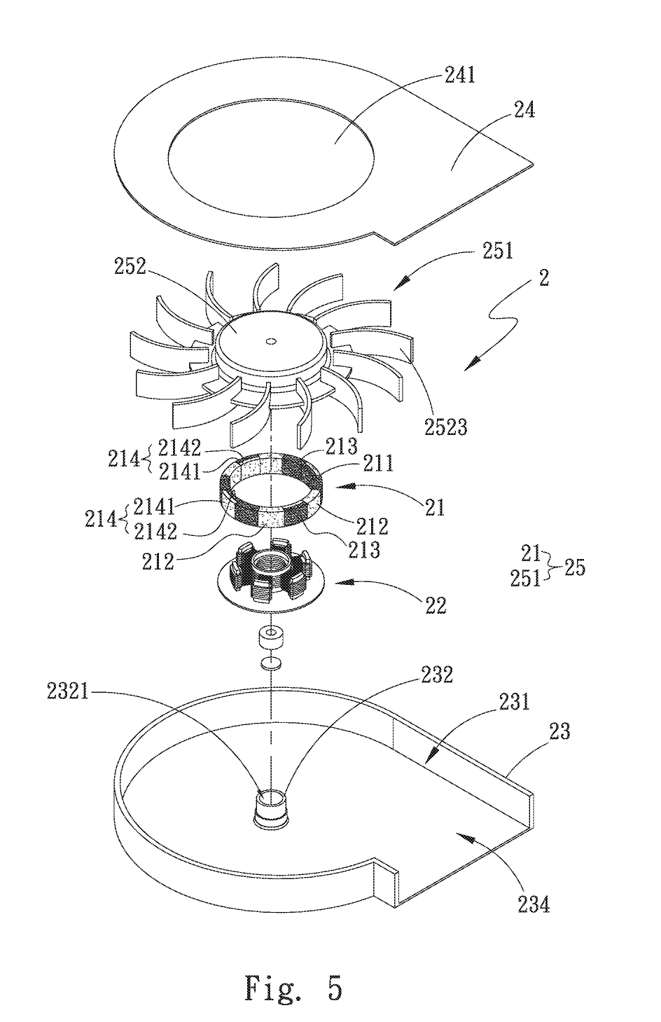

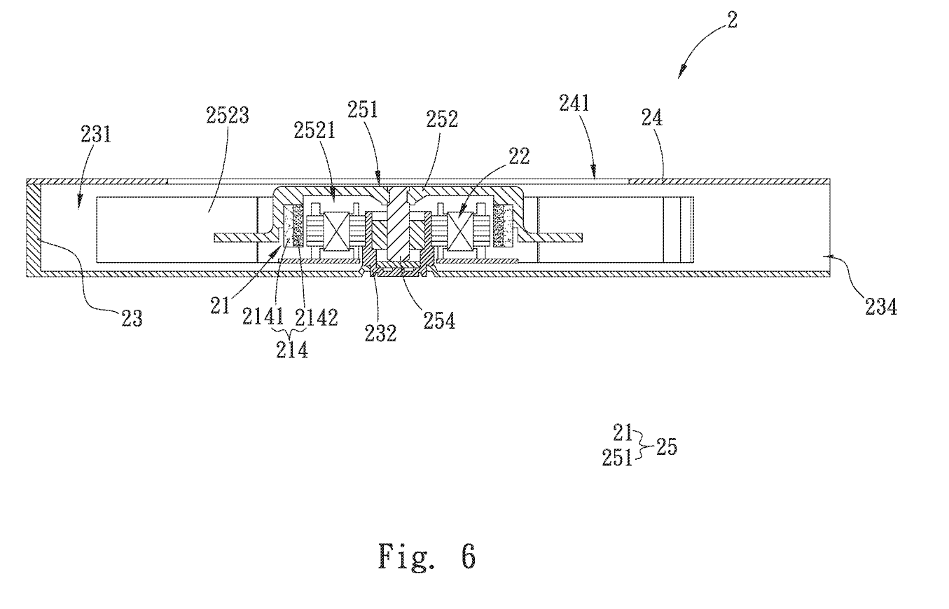

Please now refer to FIGS. 5 and 6. FIG. 5 is a perspective exploded view of the preferred embodiment of the present invention. FIG. 6 is a sectional assembled view of the preferred embodiment of the present invention. Also supplementally referring to FIGS. 3 and 3A, the permanent magnetic member 21 is applied to a fan 2. In this embodiment, the fan 2 is, but not limited to, a centrifugal fan 2. The fan 2 includes a rotor 25, a stator 22, a cover board 24 and a frame body 23. The cover board 24 is mated with the frame body 23 to cover the same. The cover board 24 is formed with an air inlet 241. The frame body 23 has a receiving space 231 in communication with the air inlet 241 and a base seat 232 disposed at the center of the receiving space 231. An air outlet 234 is disposed on one side of the frame body 23 in communication with the receiving space 231. The stator 22 is disposed on the base seat 232. The rotor 25 is received in the receiving space 231 to enclose the corresponding stator 22. The first and second magnetic pole sections 212, 213 of the main body 211 of the permanent magnetic member 21 in the rotor 25 will interact with the corresponding stator 22 by means of induction and magnetization, whereby the rotor 25 will rotate within the receiving space 231.

In this embodiment, the rotor 25 is a yoke-free rotor 25, (that is, a rotor 25 without motor case). The rotor 25 includes a fan impeller 251 and at least one permanent magnetic member 21. The fan impeller 251 has a hub 252 and multiple blades 2523 annularly arranged on the outer circumference of the hub 252. The hub 252 is made of plastic material. The hub 252 has a shaft 254 and a receiving space 2521. One end of shaft 254 is fixedly disposed at the center of the hub 252 in the receiving space 2521. The other end of the shaft 254 is rotatably disposed in a corresponding bearing cup 2321 of the base seat 232. No rotor yoke (such as motor iron case) is disposed in the hub 252. The permanent magnetic member 21 of this embodiment is identical to the permanent magnetic member 21 of the above first embodiment in structure, connection relationship and effect and thus will not be repeatedly described hereinafter. In this embodiment, the permanent magnetic member 21 is directly adhered to the inner circumference of the hub 252 in the receiving space 2521. In practice, the permanent magnetic member 21 can be alternatively integrated with the hub 252 by injection molding, whereby the permanent magnetic member 21 is integrally enclosed in the inner circumference of the hub 252.

The permanent magnetic member 21 of the present invention is applied to the fan 2 so that the rotor 25 is free from the conventional additional rotor yoke 102 (as shown in FIG. 2C). In this case, the room and cost are effectively saved and the total weight is reduced. Moreover, the present invention can effectively enhance the air gap magnetic flux density and achieve better magnetic flux sine property.

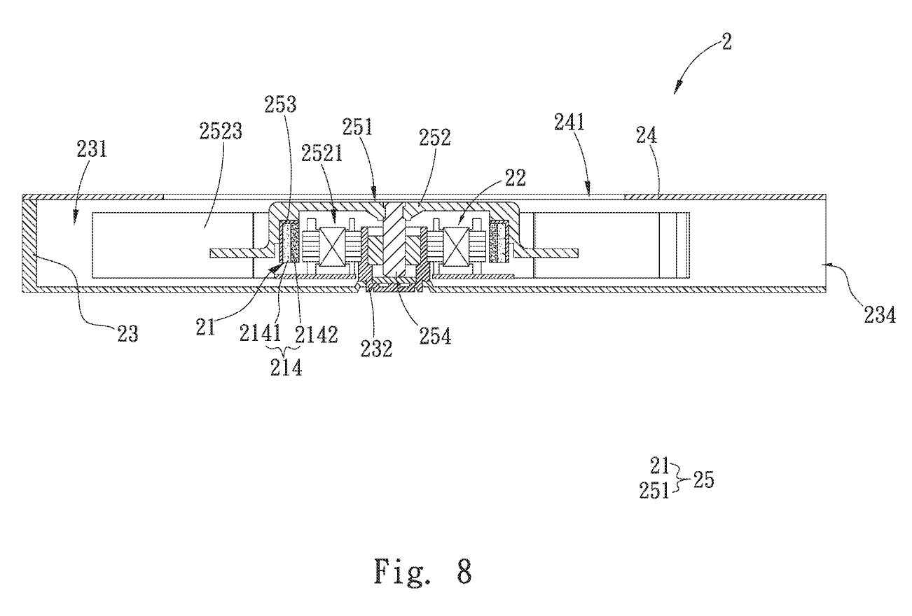

Please now refer to FIG. 8 and supplementally to FIG. 5. FIG. 8 is a sectional assembled view of another preferred embodiment of the present invention. In this embodiment, a rotor yoke 253 is disposed in the hub 252 of the rotor 25 of the fan 2. The rotor yoke 253 is made of impermeable material, (that is, the motor case is made of impermeable material). The impermeable material is plastic material or aluminum material. The rotor yoke 253 is disposed on the inner circumference of the hub 252 in the receiving space 2521 and positioned between the main body 211 and the hub 252. The main body 211 of the permanent magnetic member 21 is received and adhered to the inner circumference of the rotor yoke 253. Accordingly, the permanent magnetic member 21 of the present invention is applied to the fan 2 so that the rotor yoke 253 made of impermeable material can be employed in the rotor 25. In this case, the cost is effectively saved and the total weight is reduced. Moreover, the present invention can effectively enhance the air gap magnetic flux density and achieve better magnetic flux sine property.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A rotor permanent magnetic member comprising a main body, the main body having multiple first magnetic pole section, multiple second magnetic pole sections and multiple complex magnetic pole sections, the first and second magnetic pole sections being disposed on the main body in adjacency to each other, each complex magnetic pole section being positioned between each two first magnetic pole sections to separate each two first magnetic pole sections, each complex magnetic pole section being positioned between each two second magnetic pole sections to separate each two second magnetic pole sections, each complex magnetic pole section having at least one N-pole section and at least one S-pole section.

2. The rotor permanent magnetic member as claimed in claim 1, wherein one side of each first magnetic pole section is adjacent to one side of each second magnetic pole section, the other side of each first magnetic pole section being adjacent to each complex magnetic pole section, the other side of each second magnetic pole section being adjacent to each complex magnetic pole section.

3. The rotor permanent magnetic member as claimed in claim 2, wherein the first and second magnetic pole sections are formed on the main body by means of radial magnetization, the first magnetic pole sections being N-pole sections or S-pole sections, the second magnetic pole sections being S-pole sections or N-pole sections.

4. The rotor permanent magnetic member as claimed in claim 1, wherein the N-pole section and S-pole section of each complex magnetic pole section are formed on the main body by means of radial magnetization, the N-pole section and S-pole section between each two first magnetic pole sections being respectively disposed in adjacency to an inner circumference of the main body and an outer circumference of the main body, the N-pole section and S-pole section between each two second magnetic pole sections being respectively disposed in adjacency to the outer circumference of the main body and the inner circumference of the main body.

5. The rotor permanent magnetic member as claimed in claim 1, wherein the main body is a permanent magnet.

6. The rotor permanent magnetic member as claimed in claim 1, wherein the first and second magnetic pole sections are forward and backward radially side by side arranged in adjacency to each other and the N-pole section and S-pole section of each complex magnetic pole section are left and right radially side by side arranged in adjacency to each other.

7. The rotor permanent magnetic member as claimed in claim 1, wherein the main body is formed by means of radial multipole double-ring cross array magnetization.

8. A rotor comprising:
a fan impeller, the fan impeller including a hub and multiple blades annularly arranged on an outer circumference of the hub, the hub having a receiving space; and
at least one permanent magnetic member disposed on an inner circumference of the hub in the receiving space, the permanent magnetic member including a main body, the main body having multiple first magnetic pole section, multiple second magnetic pole sections and multiple complex magnetic pole sections, the first and second magnetic pole sections being disposed on the main body in adjacency to each other, each complex magnetic pole section being positioned between each two first magnetic pole sections to separate each two first magnetic pole sections, each complex magnetic pole section being positioned between each two second magnetic pole sections to separate each two second magnetic pole sections, each complex magnetic pole section having at least one N-pole section and at least one S-pole section.

9. The rotor as claimed in claim 8, wherein one side of each first magnetic pole section is adjacent to one side of each second magnetic pole section, the other side of each first magnetic pole section being adjacent to each complex magnetic pole section, the other side of each second magnetic pole section being adjacent to each complex magnetic pole section.

10. The rotor as claimed in claim 9, wherein the first and second magnetic pole sections formed on the main body by means of radial magnetization, the first magnetic pole sections being N-pole sections or S-pole sections, the second magnetic pole sections being S-pole sections or N-pole sections.

11. The rotor as claimed in claim 8, wherein the N-pole section and S-pole section of each complex magnetic pole section are formed on the main body by means of radial magnetization, the N-pole section and S-pole section between each two first magnetic pole sections being respectively disposed in adjacency to an inner circumference of the main body and an outer circumference of the main body, the N-pole section and S-pole section between each two second magnetic pole sections being respectively disposed in adjacency to the outer circumference of the main body and the inner circumference of the main body.

12. The rotor as claimed in claim 8, wherein the main body is a permanent magnet.

13. The rotor as claimed in claim 8, wherein the hub is made of plastic material and no rotor yoke is disposed in the hub, the permanent magnetic member being directly adhered to the inner circumference of the hub in the receiving space.

14. The rotor as claimed in claim 8, wherein the hub is made of plastic material and a rotor yoke is disposed in the hub, the rotor yoke being made of impermeable material, the rotor yoke being disposed on the inner circumference of the hub in the receiving space and positioned between the main body and the hub, the permanent magnetic member being received and adhered to the inner circumference of the rotor yoke.

15. The rotor as claimed in claim 14, wherein the impermeable material is plastic material or aluminum material.

16. A fan comprising:
a frame body, the frame body having a receiving space and a base seat disposed at a center of the receiving space;
a cover board being mated with the frame body to cover the same;
a stator disposed on the base seat; and
a rotor received in the receiving space to enclose the corresponding stator, and the rotor comprising:
a fan impeller, the fan impeller including a hub and multiple blades annularly arranged on an outer circumference of the hub, the hub having a receiving space; and
at least one permanent magnetic member disposed on an inner circumference of the hub in the receiving space, the permanent magnetic member including a main body, the main body having multiple first magnetic pole section, multiple second magnetic pole sections and multiple complex magnetic pole sections, the first and second magnetic pole sections being disposed on the main body in adjacency to each other, each complex magnetic pole section being positioned between each two first magnetic pole sections to separate each two first magnetic pole sections, each complex magnetic pole section being positioned between each two second magnetic pole sections to separate each two second magnetic pole sections, each complex magnetic pole section having at least one N-pole section and at least one S-pole section.

17. A rotor permanent magnetic member comprising a main body, the main body having multiple first magnetic pole section and multiple second magnetic pole sections, the first and second magnetic pole sections being alternately arranged on the main body in adjacency to each other, each first magnetic pole section being formed with a magnetic pole section as a part of the first magnetic pole section with a polarity different from the polarity of the first magnetic pole section, each second magnetic pole section being formed with a magnetic pole section as a part of the second magnetic pole section with a polarity different from the polarity of the second magnetic pole section.
